(19) United States
(12) Patent Application Publication
(10) Pub. No.: US 2002/0085344 A1
(43) Pub. Date: Jul. 4, 2002

(54) Personal data assistant carrying apparatus

(76) Inventor: Waddell Fields, Suwanee, GA (US)

Correspondence Address: MYERS & ASSOCIATES, INTELLECTUAL, PROPERTY LAW, P.C., SUITE 200, BUILDING 3, 1827 POWERS FERRY ROAD, ATLANTA, GA, 30339, US

(21) Appl. No.: 09/991,375

(22) Filed: Nov. 16, 2001

Related U.S. Application Data
(60) Provisional application No. 60/249,227, filed on Nov. 16, 2000.

(51) Int. Cl. G06F 1/16

(52) U.S. Cl. 361/683; 361/679

(57) ABSTRACT

A carrying device enabling hands-free transporting of a personal data assistant (PDA) wherein a clipping mechanism removably secures the device to a user and a resiliently wound mechanism acts to enable comfortably adjustable, securely linked access to a PDA, thereby providing hands-free carrying and virtually eliminating risk of loss from accidental misplacement.

### BACKGROUND OF THE INVENTION

Modern lifestyle often necessitates busy and complex schedules for all ages. As a result, personal calendars, diaries and other scheduling aides have become commonplace. Recent advancements in technology have allowed for the proliferation of portable high-tech scheduling devices. These devices, commonly known as personal data assistants (PDA's), not only offer paper-free calendars but also act as portable data storage and processing units. The versatility and power of the PDA, in combination with its easy portability, have led to a rapid and consistent increase in PDA users.

Typical users rely on the PDA for a large variety of tasks. Business users, especially those frequently away from the traditional office, place especially high value on these portable information processing devices. While most PDA's are capable of directly linking to a desktop or laptop computer, it is their capability to work efficiently as a stand-alone device that is the basis of their popularity. As such, the data held within a PDA is often valuable, confidential and many times irreplaceable.

Accidental loss of a PDA is, at best, an expensive, time-consuming inconvenience when data can be reconstructed from other sources. When data is irreplaceable, however, loss of a PDA can be personally and financially devastating. Prevention of such a loss, therefore, is of the utmost importance. Unfortunately, many PDA users are frequent business travelers who find themselves working at a variety of makeshift locations. The small size of the PDA, a benefit providing for easy portability, detrimentally makes the PDA easy to overlook and forget. Even the most organized individuals occasionally walk away and mistakenly leave personal property items behind. For a device as essential as the PDA, such an error must be prevented.

Therefore, it is readily apparent that there is a need for a PDA carrying device enabling easy accessibility and usage thereof, wherein accidental misplacement is prevented and hands-free transportation is provided thus preventing the above-discussed disadvantages.

### BRIEF SUMMARY OF THE INVENTION

Briefly described, in a preferred embodiment, the present invention overcomes the above-mentioned disadvantages, and meets the recognized need for such a device, by providing a PDA carrying device wherein a resiliently wound mechanism acts to enable comfortably adjustable linked access to a PDA, thereby providing hands-free carrying and virtually eliminating risk of loss from accidental misplacement.

According to its major aspects and broadly stated, the present invention is a PDA carrying apparatus, wherein an adjustable hook securely attaches to the PDA and a clipping mechanism removably secures the device to the user.

More specifically, the present invention is a PDA carrying device adapted to be worn by a user, wherein a PDA is secured thereto and resilient access is provided thereby.

A feature and advantage of the present invention is the ability of such a device to provide a PDA carrying device that is simple in construction and thus easy to manufacture.

A feature and advantage of the present invention is the ability of such a device to provide hands-free carrying of a PDA.

A feature and advantage of the present invention is the ability of such a device to prevent accidental misplacement of a PDA.

A feature and advantage of the present invention is the ability of such a device to allow easy user-accessibility to a PDA.

A feature and advantage of the present invention is the ability of such a carrying device to resiliently link a PDA to a user.

A feature and advantage of the present invention is to provide a device that prevents the dropping, slipping or falling of a PDA from out of a pocket, a briefcase or one's hands.

A feature and advantage of the present invention is the ability of such a device to allow secure user carriage thereof while preventing limitation of usage locations.

A feature and advantage of the present invention is the ability of such a device to enable carrying of heavy objects without undesired extension, etc.

These and other objects, features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a rear perspective view of a PDA carrying device according to a preferred embodiment of the present invention shown in an unexpanded position.

FIG. 2 is a perspective view of the hooking and locking portion of the PDA carrying device of FIG. 1 shown in an expanded position.

FIG. 3 is a rear perspective view of a PDA carrying device according to an alternate embodiment of the present invention shown in a locked unexpanded position.

FIG. 4 is a perspective view of the hooking and locking portion of the PDA carrying device of FIG. 3 shown in an unlocked expanded position.

FIG. 5 is a perspective view of the PDA carrying device of FIG. 3 shown having a PDA attached thereto.

FIG. 6 is a front perspective view of a PDA carrying device according to an alternate embodiment of the present invention shown in an unexpanded position.

FIG. 7 is a rear perspective view of a PDA carrying device according to an alternate embodiment of the present invention shown in an unexpanded position.

FIG. 8 is a front perspective view of a PDA carrying device according to an alternate embodiment of the present invention shown in a locked unexpanded position.

FIG. 9 is a rear perspective view of a PDA carrying device according to an alternate embodiment of the present invention shown in a locked unexpanded position.

### DETAILED DESCRIPTION OF THE PREFERRED AND ALTERNATE EMBODIMENTS

In describing the preferred and alternate embodiments of the present invention, as illustrated in the figures, specific terminology is employed for the sake of clarity. The invention, however, is not intended to be limited to the specific terminology so selected, and it is to be understood that each specific element includes all technical equivalents that operate in a similar manner to accomplish similar functions.

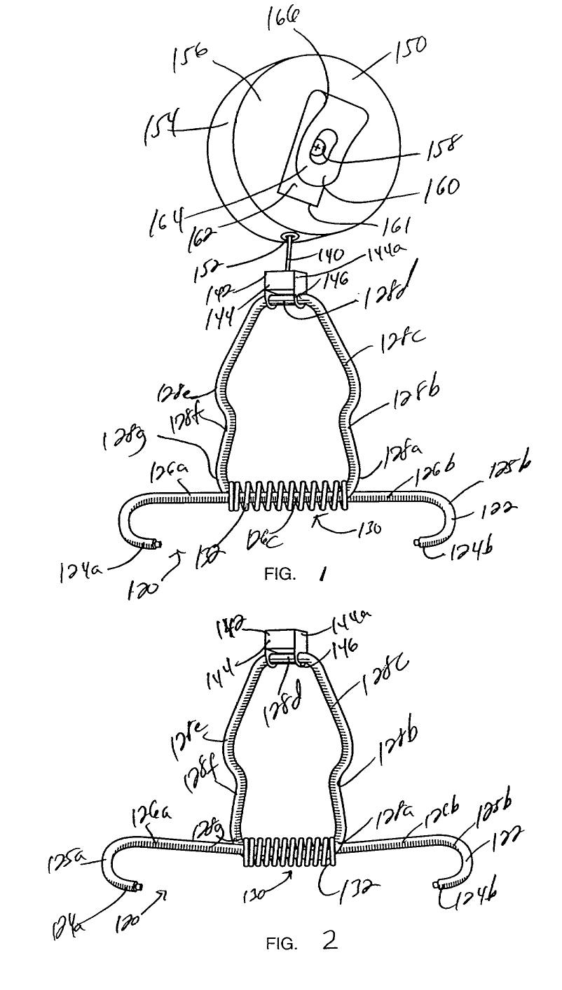

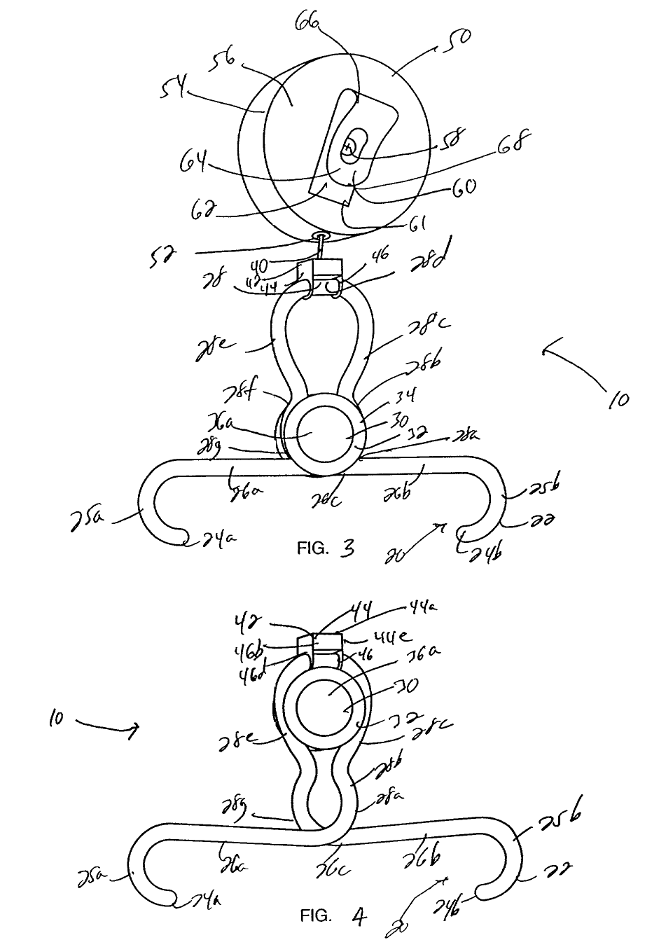

Referring now to FIGS. 1 and 2, the present invention is a PDA carrying device 100 comprising hooking means 120, locking means 130, cable 140, housing 150 and clipping means 160. Hooking means 120 is preferably formed from an elongated, substantially cylindrically shaped metal rod 122 wherein rod 122 has first end 124a, second end 124b, first arcuate section 125a, second arcuate section 125b, first substantially straight section 126a, second substantially straight section 126b and shaped loop 128.

Preferably, the diameter of rod 122 is dimensioned to permit first end 124a and second end 124b to enter and securely reside within known apertures located within the peripheral edges of a PDA, such as, for exemplary purposes only, a PDA sold under the trademark PALMPILOT. First arcuate section 125a and second arcuate section 125b are preferably dimensioned to permit pivotal movement of a PDA about first end 124a and second end 124b of hooking means 120 when attached thereto. The length of first substantially straight section 126a is substantially equivalent to the length of second substantially straight section 126b wherein first substantially straight section 126a is preferably parallel with second substantially straight section 126b. The span of hooking means 120 is dimensioned to permit pivotal movement of a PDA about first end 124a and second end 124b when attached thereto and is less than the sum of the lengths of first substantially straight section 126a and second substantially straight section 126b wherein overlap of straight sections 126a and 126b occurs in section 126c wherein first substantially straight section 126a lies proximate to second substantially straight section 126b without contact therewith in section 126c.

Shaped loop 128 is defined by rod 122 wherein rod 122 extends away from first substantially straight section 126a forming first upper loop corner 128a. Rod 122 extends, substantially straight, from first upper loop corner 128a to first loop indention 128b, extending outwardly at an angle to first loop arc 128c. Preferably, rod 122 extends from first loop arc 128c to loop base point 128d, extending therefrom to second loop arc 128e. Rod 122 extends inwardly at an angle to second loop indention 128f and therefrom substantially straight to second upper loop corner 128g, wherein second upper loop corner 128g extends outwardly from second substantially straight section 126b.

Locking means 130 is a preferably a spring 132 positioned around section 126a and 126b and held in place by first upper loop corner 128a and second upper loop corner 128g. Spring 132 is held in compression thereby urging first upper loop corner 128a and second upper loop corner 128g apart and thus first end 124a and second end 124b toward each other. As a result, first end 124a and second end 124b are urged together thereby securing the PDA therebetween. It is contemplated in an alternate embodiment that PDA carrying device 100 could be formed without spring 132 as a locking means 130, wherein securement of the PDA between first end 124a and second end 124b could be accomplished by forming rod 122 of hooking means 120 from a material of sufficient resilience to enable manual compression of first loop indention 128b and second loop indention 128f, thereby resulting in expansion of the distance between first end 124a and second end 124b for fitting and placing the PDA therebetween. Subsequent to a release of first loop indention 128b and second loop indention 128f, the resilience of rod 122 would provide decreased distance between first end 124a and second end 124b and thus tensioned securement of first end 124a and second end 124b on the sides of the PDA.

Cable 140 is movably positioned along loop 128 within connecting means 142. Preferably, connecting means 142 is a metal bracket 144 having a substantially square base 144a, two substantially square side walls 144b and 144c, and two connecting walls 144d and 144e. Base 144a defines a substantially circular shaped aperture wherein cable 140 passes therethrough and preferably, wherein bead 148 carried on first end 140a of cable 140 prevents return passage thereof. Connecting walls 144d and 144e are substantially rectangular shaped with substantially circular shaped aperture 146 defined therethrough wherein aperture 146 is dimensioned to allow unencumbered passage of rod 122 therethrough thereby connecting cable 140, via bracket 144, to loop 128.

Preferably, cable 140 is a flexible, plastic coated wire cable. Second end 140b of cable 140 is fixed within housing 150 wherein cable 140 is resiliently wound, passing through substantially circular housing aperture 152 in peripheral sidewall 154. Preferably, the resilient force urging first end 140a of cable 140 to return to housing 150 may be counterbalanced by the weight of a PDA attached to carrying device 100 coupled with minimal user resistance thereby allowing use of an attached PDA.

Housing 150 has a preferably substantially circular shaped, substantially flat outer surface 156 wherein screw 158 is preferably centrally located therein and clipping means 160 is carried thereby. Screw 158 provides accessible, secure closure to housing 150 and removable attachment of clipping means 160.

Clipping means 160 is preferably formed from a substantially flat, substantially elongated rectangular shaped metal plate 161 having first end 162 and second end 164. First end 162 is preferably fixed within housing 150 wherein plate 161 extends therefrom, proximate to outer surface 156, substantially flush thereagainst. Plate 161 curves away from outer surface 156 forming looped end 166, folding back on itself, extending substantially flat and at an angle to bend 168 wherein second end 164 curves away from first end 162. Preferably second end 164 is rounded. Bend 168 is positioned proximate to first end 162 without contact therewith, wherein a user attaches clipping means 160 by sliding his or her belt, pocket or other clothing or personal article between second end 164 and first end 162 of clipping means 160 and wherein clipping means 160 effectively grips the personal article.

In use, first loop indention 128b and second loop indention 128f are squeezed together thereby spreading apart first end 124a and second end 124b as shown in FIG. 2. Next, a PDA is positioned therebetween, wherein first end 124a and second end 124b of rod 122 are positioned within known apertures located within the peripheral edges of a PDA. Spring 132 urges first end 124a and second end 124b together thereby locking the PDA to device 100.

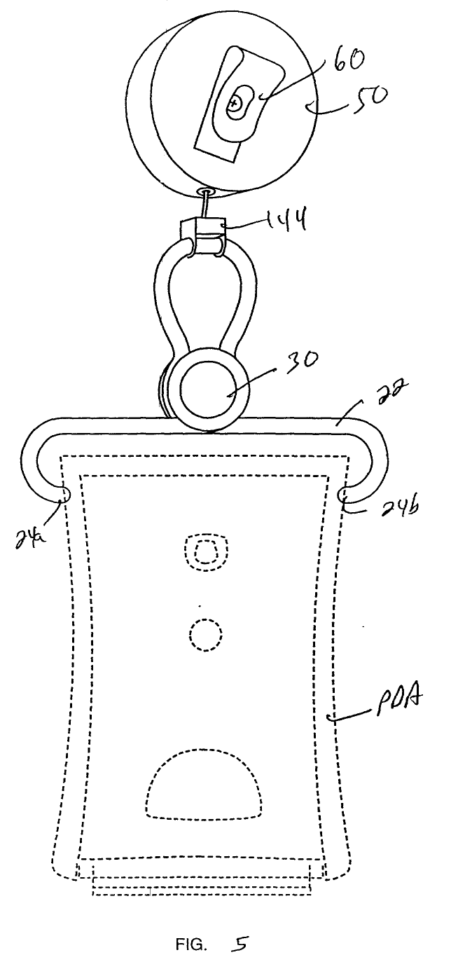

Referring now to FIGS. 3-5, an alternate embodiment of the present invention is a PDA carrying device 10 comprising hooking means 20, locking means 30, cable 40, housing 50 and clipping means 60. Hooking means 20 is preferably formed from an elongated, substantially cylindrically shaped metal rod 22 wherein rod 22 has first end 24a, second end 24b, first arcuate section 25a, second arcuate section 25b, first substantially straight section 26a, second substantially straight section 26b and shaped loop 28.

Preferably, the diameter of rod 22 is dimensioned to permit first end 24a and second end 24b to enter and securely reside within known apertures located within the peripheral edges of a PDA, such as, for exemplary purposes only, PALMPILOT. First arcuate section 25a and second arcuate section 25b are preferably dimensioned to permit pivotal movement of a PDA about first end 24a and second end 24b of hooking means 20 when attached thereto. The length of first substantially straight section 26a is substantially equivalent to the length of second substantially straight section 26b wherein first substantially straight section 26a is preferably parallel with second substantially straight section 26b. The span of hooking means 20 is dimensioned to permit pivotal movement of a PDA about first end 24a and second end 24b when attached thereto and is less than the sum of the lengths of first substantially straight section 26a and second substantially straight section 26b wherein overlap of straight sections 26a and 26b occurs in section 26c wherein first substantially straight section 26a lies proximate to second substantially straight section 26b without contact therewith in section 26c.

Shaped loop 28 is defined by rod 22 wherein rod 22 extends away from first substantially straight section 26a forming first upper loop corner 28a. Rod 22 extends, substantially straight, from first upper loop corner 28a to first loop indention 28b, extending outwardly at an angle to first loop arc 28c. Preferably, rod 22 extends from first loop arc 28c to loop base point 28d, extending therefrom to second loop arc 28e. Rod 22 extends inwardly at an angle to second loop indention 28f and therefrom substantially straight to second upper loop corner 28g, wherein second upper loop corner 28g extends outwardly from second substantially straight section 26b. Loop 28 is dimensioned to retain locking means 30 therein, wherein first loop arc 28c and second loop arc 28e hold locking means 30 in an at-rest, unlocked position and wherein first loop indention 28b and second loop indention 28f hold locking means 30 in a locked position, thereby fixing the position of first end 24a and second end 24b within known apertures on a PDA.

Locking means 30 is a preferably substantially circular shaped plastic disc 32 having a recessed peripheral wall 34 encircling the circumference thereof, a first outer surface 36a and a second outer surface 36b wherein recessed peripheral wall 34 resides therebetween. Recessed peripheral wall 34 of locking means 34 is dimensioned to receive rod 22 wherein first loop indention 28b and second loop indention 28f of loop 28 press thereagainst thereby locking PDA carrying device 10 onto a PDA.

Cable 40 is movable positioned along loop 28 within connecting means 42. Preferably, connecting means 42 is a metal bracket 44 having a substantially square base 44a, two substantially square side walls 44b and 44c, and two connecting walls 44d and 44e. Base 44a defines a substantially circular shaped aperture wherein cable 40 passes therethrough and preferably, wherein bead 48 carried on first end 40a of cable 40 prevents return passage thereof. Connecting walls 44d and 44e are substantially rectangular shaped with substantially circular shaped aperture 46 defined therethrough wherein aperture 46 is dimensioned to allow unencumbered passage of rod 22 therethrough thereby connecting cable 40, via bracket 44, to loop 28.

Preferably, cable 40 is a flexible, plastic coated wire cable. Second end 40b of cable 40 is fixed within housing 50 wherein cable 40 is resiliently wound, passing through substantially circular housing aperture 52 in peripheral sidewall 54. Preferably, the resilient force urging first end 40a of cable 40 to return to housing 50 may be counterbalanced by the weight of a PDA attached to carrying device 10 coupled with minimal user resistance thereby allowing use of an attached PDA.

Housing 50 has a preferably substantially circular shaped, substantially flat outer surface 56 wherein screw 58 is preferably centrally located therein and clipping means 60 is carried thereby. Screw 58 provides accessible, secure closure to housing 50 and removable attachment of clipping means 60.

Clipping means 60 is preferably formed from a substantially flat, substantially elongated rectangular shaped metal plate 61 having first end 62 and second end 64. First end 62 is preferably fixed within housing 50 wherein plate 61 extends therefrom, proximate to outer surface 56, substantially flush thereagainst. Plate 61 curves away from outer surface 56 forming looped end 66, folding back on itself, extending substantially flat and at an angle to bend 68 wherein second end 64 curves away from first end 62. Preferably second end 64 is rounded. Bend 68 is positioned proximate to first end 62 without contact therewith, wherein a user attaches clipping means 60 by sliding his or her belt, pocket or other clothing or personal article between second end 64 and first end 62 of clipping means 60 and wherein clipping means 60 effectively grips the personal article.

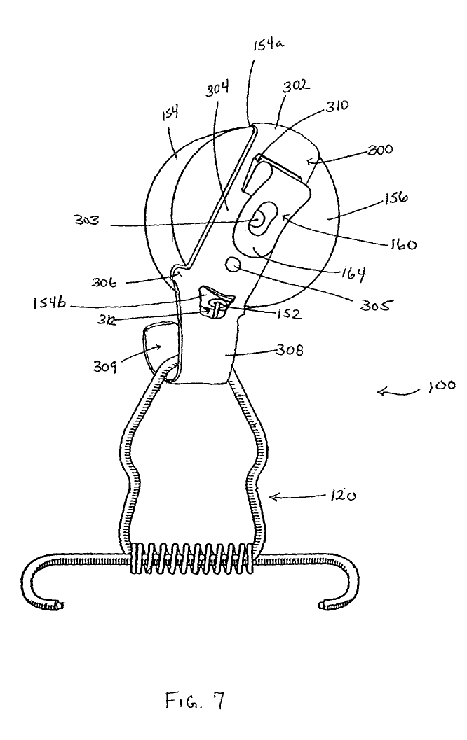

Referring now to FIGS. 6-7, it is contemplated in an alternate embodiment that PDA carrying device 100 as described in FIGS. 1-2 could comprise a catch hook 300, preferably removably attachable to housing 150 of device 100. Catch hook 300 is preferably metal with first grip portion 302 extending generally perpendicular to elongated portion 304, wherein second grip portion 306 extends generally perpendicularly from elongated portion 304. Preferably, hook 308 is substantially flat, generally V-shaped, and extends from second grip portion 306.

Elongated portion 304 preferably further comprises first slot 310 proximal to first grip portion 302. Second slot 312 is preferably defined within second grip portion 306 and hook 308, generally positioned at the intersection of second grip portion 306 and hook 308. The preferred length of elongated portion 304 enables placement of slot 310 over second end 164 of clipping means 160, wherein first rip portion 302 abuts area 154a of peripheral sidewall 154 of housing 150 and second grip portion 306 can be pushed against flat outer surface 156, thereby tensionly grasping and engaging area 154b of peripheral sidewall 154. Upon tensioned engagement of catch hook 300 with housing 150, slot 312 is positioned proximate to substantially circular housing aperture 152 on peripheral sidewall 154. Catch hook 300 preferably functions to prevent undesired extension of cable 140 by catching, holding and/or seating metal bracket 144 of connecting means 142 within surface 309 of hook 308.

Elongated portion 304 defines throughholes 303 and 305 thereby enabling catch hock 300 to be fixedly secured to flat outer surface 156 via any securing means known within the art, such as, for exemplary purposes only, screws, bolts or rivets.

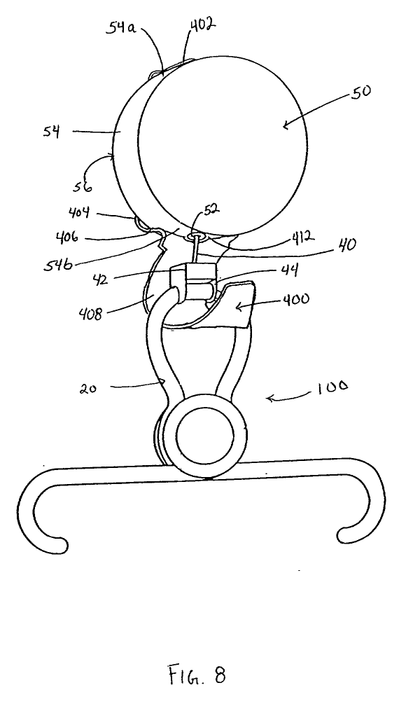

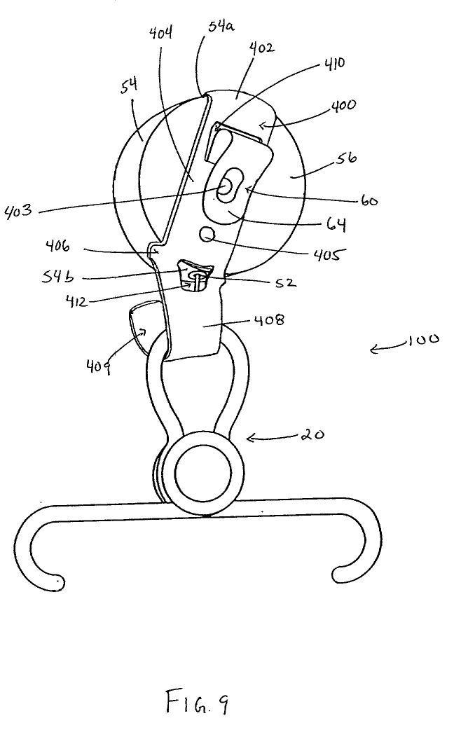

Referring now to FIGS. 8-9, it is contemplated in an alternate embodiment that device 100 as described in FIGS. 3-5 could comprise a catch hook 400 preferably removably attachable to housing 50 of device 100. Catch hook 400 is preferably metal with first grip portion 402 extending generally perpendicular to elongated portion 404, wherein second grip portion 406 extends generally perpendicularly from elongated portion 404. Preferably, hook 408 is substantially flat, generally V-shaped, and extends from second grip portion 406.

Elongated portion 404 preferably further comprises first slot 410 proximal to first grip portion 402. Second slot 412 is preferably defined within second grip portion 406 and hook 408, generally positioned at the intersection of second grip portion 406 and hook 408. The preferred length of elongated portion 404 enables placement of slot 410 over second end 64 of clipping means 60, wherein first grip portion 402 abuts area 54a of peripheral sidewall 54 of housing 50 and second grip portion 406 can be pushed against flat outer surface 56, thereby tensionly grasping and engaging area 54b of peripheral sidewall 54. Upon tensioned engagement of catch hook 400 with housing 50, slot 412 is positioned proximate to substantially circular housing aperture 52 on peripheral sidewall 54. Catch hook 400 preferably functions to prevent undesired extension of cable 40 by catching, holding and/or seating metal bracket 44 of connecting means 42 within surface 409 of hook 408.

Elongated portion 404 defines throughholes 403 and 405 thereby enabling catch hook 400 to be fixedly secured to flat outer surface 56 via any securing means known within the art, such as, for exemplary purposes only, screws, bolts or rivets.

In an alternate embodiment, hooking means 20 could be formed from a sturdy plastic.

In another alternate embodiment, locking means 30 could be formed from metal or rubber.

In still another alternate embodiment, cable 40 could be flexible metal cable, woven fibers or plastic.

In yet another alternate embodiment, connecting means 42 could be an eye assembly secured to first end 40a of cable 40 wherein the eye throughhole would be movably positioned along loop 28.

In still yet another alternate embodiment, metal bracket 44 could be formed from plastic.

In still another alternate embodiment, the resilient force urging first end 40a of cable 40 to return to housing 50 could be adjustable.

In another alternate embodiment, housing 50 could carry a stopping means to allow a user to selectively block the resilient force urging cable 40 to return to housing 50.

In yet another alternate embodiment, cable 40 could be resiliently wound within housing 50 wherein upon unwinding of cable 40 to a specified length, an automatic stop mechanism could be engaged to block the resilient force urging cable 40 to return to housing 50, an wherein, at the user's discretion, additional unwinding of cable 40 could disengage the automatic stop mechanism thereby releasing the resilient force urging cable 40 to return to housing 50.

In still another alternate embodiment, housing 50 could be of any geometric shape.

In yet still another alternate embodiment, housing 50 could be provided with a threaded closure mechanism to allow accessible, secure closure thereof.

In another alternate embodiment, clipping means 60 could be an integral formed part of housing 50.

In yet another alternate embodiment, clipping means 60 could be plastic.

In still another alternate embodiment, clipping means 60 could provide a spring-loaded clip mechanism.

In yet still another alternate embodiment, a multitude of indicia including, but not limited to, company logos and advertisements, licensed characters, and educational institution logos and advertisements may be imprinted on outer surfaces 36a and 36b of locking means 30 and/or housing 50.

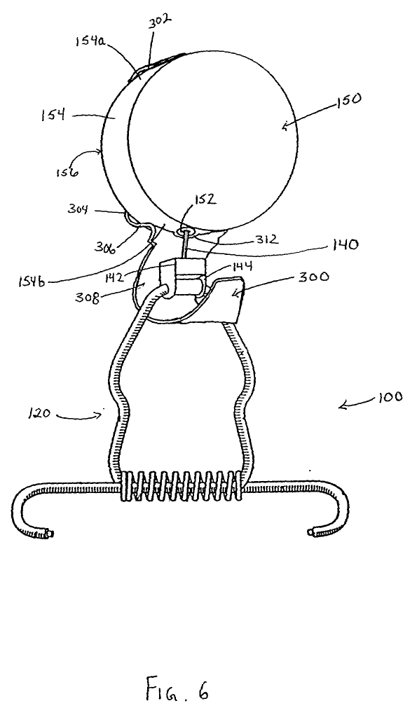

In use, locking means 30 is placed in an unlocked, at-rest position between first loop arc 28c and second loop arc 28e of shaped loop 28, as best seen in FIG. 4, and hooking means 20 is attached to a PDA wherein first end 24a and second end 24b of rod 22 are positioned within known apertures located within the peripheral edges of a PDA. Locking means 30 is then moved within loop 28 wherein first loop indention 28b and second loop indention 28f hold locking means 30 in a locked position, thereby fixing the position of first end 24a and second end 24b within the PDA apertures, securing hooking means 20 thereon.

The PDA may be carried, hands-free, by attaching clipping means 60 to a user's belt, pocket or other clothing or personal article between second end 64 and first end 62 of clipping means 60 and wherein clipping means 60 effectively grips the belt or pocket. To access and use the PDA, a user pulls on the PDA secured to hooking means 20, thereby causing cable 40 to unwind. In use, the resilient force urging cable 40 to return to housing 50 is counterbalanced by the weight of a PDA coupled with a minimal user resistance thereby permitting secure and comfortable access thereto. If the user should forget to replace his or her PDA after use, the PDA carrying device 10 automatically recoils cable 40 preventing accidental loss thereof.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A carrying device for use with a personal data assistant (PDA), comprising:
means for attaching to the PDA;
means for removably securing said carrying device to an object; and
a housing, wherein said housing is in communication with said attaching means and said securing means.
